(19) United States
(12) Patent Application Publication
(10) Pub. No.: US 2009/0068630 A1
(43) Pub. Date: Mar. 12, 2009

(54) SELF-ADJUSTING VENTILATION OUTLET WITH MULTIPLE FLOW RATES

(76) Inventor: Marc Jardinier, Villeneuve-le-Comte (FR)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 12/298,919

(22) PCT Filed: Apr. 19, 2007
(86) PCT No.: PCT/FR2007/000654

§ 371 Date: Oct. 29, 2008

(30) Foreign Application Priority Data
May 12, 2006 (FR) 0604219

(51) Int. Cl. G09B 7/00

(52) U.S. Cl. 434/358

(57) ABSTRACT

This invention is for a ventilation outlet (1) which is self-adjusting with multiple flow rates presenting a passageway for the ventilation air and equipped with an adjustable flap (6) and comprising a control flap (7) with one face (10) meant to channel air entering and presenting, on the one hand, a connecting edge (11) equipped with an attachment means (12) making it possible to attach the control flap around an axis for a given position and, on the other hand, an opposite edge constituting a trailing edge (14) which features, from the connecting edge to the trailing edge, gradual successive flat layers making up the control flap (16 to 19) given the latter flap a clearly convex shape.

The present invention relates to a setting flap for a self-adjusting ventilation outlet with multiple flow rates, and to a ventilation outlet thus equipped.

It is well known practice to install a ventilation outlet having the ability to deliver a substantially constant flow rate irrespective of the pressure difference on either side of this ventilation outlet.

Such a ventilation outlet is called “self-adjusting”, and is used very widely in France, both in the residential sector (as a terminal) and in the tertiary sector (as a terminal or duct).

Two main types of self-adjusting ventilation outlet have been proposed.

On the one hand, ventilation outlets with a membrane in which the membrane delimits an almost closed volume which, by inflation or deflation of the membrane, is capable of varying, depending on the pressure difference, so as to modify the surface area for the passage of the ventilation air.

And on the other hand, ventilation outlets with a flat flap whose opening is regulated by the position of the flap depending on the pressure difference on either side of the outlet. Complementary springs or counterweights make it possible if necessary to be independent of gravity and to use the outlet in all positions.

The ventilation outlets with a flat flap currently proposed for delivering a predetermined fixed flow rate are relatively efficient because they usually make it possible to obtain a substantially constant flow rate value across a fairly broad pressure range, with a reduced hysteresis between the rise and fall in pressure.

Self-adjusting ventilation outlets with multiple flow rates have also already been proposed, these flow rates being obtained, depending upon the type of ventilation outlet used, by modifying the environment of the membrane or by offsetting a flap that is complementary to the conventionally used flat flap.

More precisely, self-adjusting ventilation outlets with flaps for delivering multiple flow rates comprise, on the one hand, a flat regulation flap, that is free and movable, provided for adapting to the pressure difference on either side so as to regulate the air flow rate, and, on the other hand, a flat setting flap giving the setting of the flow rate to be achieved. Specifically, depending on the position of the setting flap about its fixed shaft, which may be controlled manually, or by a remote control, or else by a motor control according to a determined parameter such as the detection of presence or the level of CO₂ for example, it is then possible to change the nominal flow rate value.

However, it has been found that these self-adjusting ventilation outlets with flat flaps for delivering multiple flow rates did not have a very satisfactory self-adjusting feature for all the declared flow rates.

The more or less efficient character of self-regulation is in fact provided by the relative positions of the surfaces of contact with the ventilation air of the two flaps, the setting flap and regulation flap. Since these relative positions may be more or less favorable, it is necessary to accept a compromise around an intermediate position, which consequently limits the obtainable range of flow rates.

In particular, since the angle that the setting flap and the regulation flap form can be varied according to the pressure conditions, there is a resulting limitation in the range of possible flow rates because the fineness of the regulation originates essentially from the value of this angle which must remain quite small.

Since the flow rate is schematically proportional to the surface area of free passage, it means that, for a given pressure difference, it is necessary to modify the passage surface area by a factor of 5 to move from a flow rate of 30 m³/h to a flow rate of 50 m³/h, which means a considerable rotation of the setting flap around its shaft. The result of this finally is that the angle formed by the setting flap and regulation flap becomes excessive and therefore no longer allows a correct regulation.

The object of the present invention is to propose a self-adjusting ventilation outlet with flaps, of simple design, to deliver multiple flow rates making it possible to obtain good performance in all the flow-rate configurations, for very wide ranges of flow rate and pressure. A very important advantage of the invention therefore lies in the fact that a single reference may be adapted to many cases, while maintaining a real and sustained overall performance.

To do this, the present invention relates to a self-adjusting ventilation outlet with multiple flow rates having a passageway for the ventilation air and having a regulation flap, and comprising a setting flap, having a face designed to channel the incoming air and having, on the one hand, a connection edge fitted with attachment means allowing the setting flap to be attached about a shaft in a predetermined position, and, on the other hand, an opposite edge forming a trailing edge, characterized in that, from the connection edge to the trailing edge, the face of the setting flap is divided into a succession of flat facets conferring a substantially convex profile on the latter.

Specifically, irrespective of the nominal value of flow rate desired, a setting flap according to the invention always has at least one flat facet having an appropriate inclination relative to the regulation flap, which finally makes it possible to considerably enhance the capacity of the ventilation outlet to self-adjust.

Preferably, the number of facets is between 2 and 10. Nevertheless, it should be well understood that the limit embodiment of a setting flap according to the invention is a flap with a continuous succession of very small flat facets conferring on the latter a continuous curvilinear profile. Such an embodiment, although covered by the present patent application, does not however constitute the best solution because the Coanda effect on the surface of the flap disrupts the regulation.

Again preferably, the facet with the largest surface area is closest to the connection edge.

Advantageously, the surface area of the facet closest to the trailing edge is greater than the surface area of the facet preceding it.

According to a variant embodiment of the setting flap according to the invention, the respective surface area of the facets decreases from the connection edge to the trailing edge.

Again advantageously, a ventilation outlet according to the invention comprises manual and/or automatic control means making it possible to change the position of the setting flap about its shaft.

The invention will be better understood with the aid of the detailed description that is set out below with reference to the appended drawing in which:

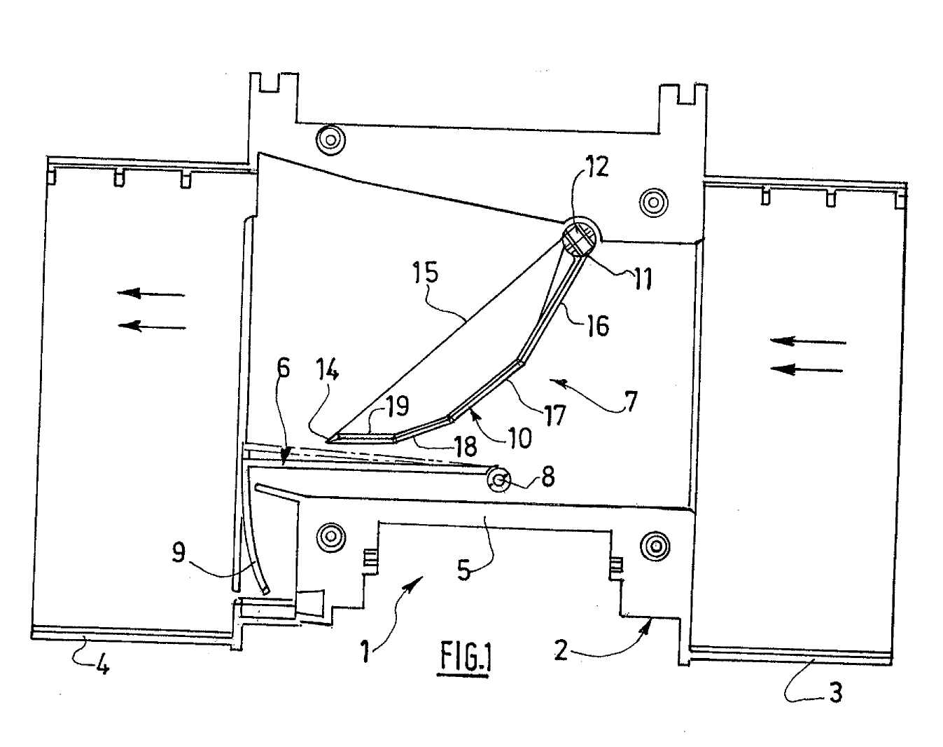

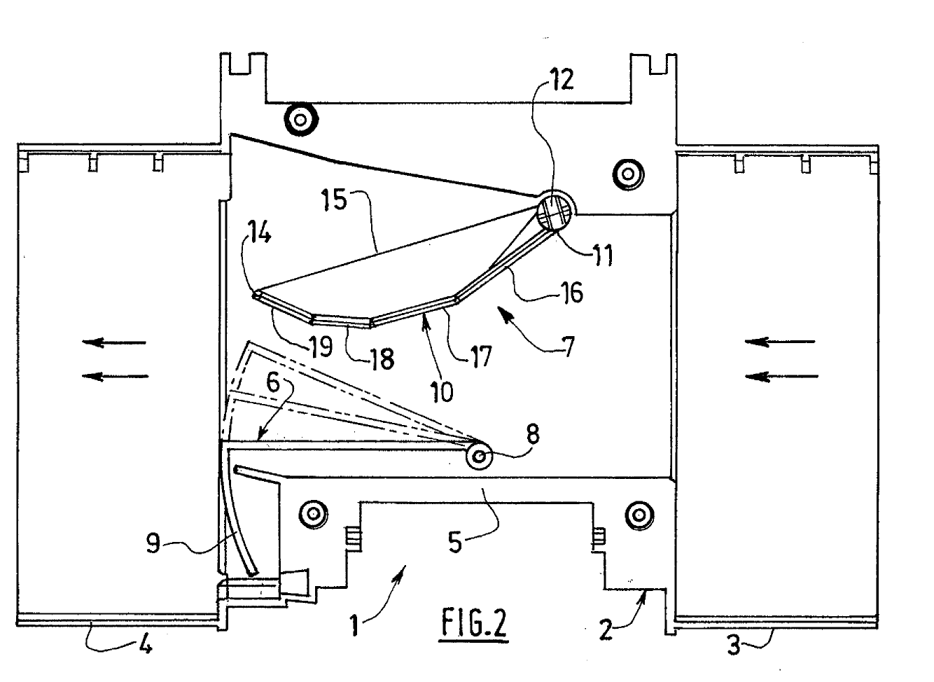

FIGS. 1 to 3 are schematic views in longitudinal section of a self-adjusting ventilation outlet according to the invention when the flow rate of air delivered is respectively at minimum, medium, maximum level.

A self-adjusting ventilation outlet 1 with multiple flow rates, respectively of 30 m³/h, 100 m³/h and 150 m³/h, as shown respectively in FIGS. 1 to 3, comprises a duct 2 having an inlet 3 and an outlet 4 separated from one another by a central portion 5 housing a regulation mechanism made with the aid of a regulation flap 6 and a setting flap 7. As shown by the arrows, the ventilation air enters the duct 2 in a conventional manner through its inlet 3, then passes through the central portion 5 and finally escapes through the outlet 4 at a regulated flow rate.

More precisely, the regulation flap 6 is made in the form of a panel mounted so as to pivot about a shaft 8 by means of a connection of the hinge type. In a conventional manner, the panel is extended on the side of its border situated close to the outlet 4, by an arc 9 directed downward. When the ventilation outlet 1 is stopped, the regulation flap 6 is kept in a substantially horizontal position. In operation, the pressure difference on either side of the regulation flap 6 causes the latter to rotate about its shaft 8, as shown in dot-and-dash lines in FIGS. 1 to 3.

The setting flap 7 comprises a face 10 designed to channel the incoming air and has, on the one hand, a connection edge 11 fitted with attachment means 12 making it possible to attach the setting flap 7 to a shaft (not shown) in a predetermined position, and, on the other hand, an opposite edge forming a trailing edge 14. The other two edges of the face 10, perpendicular to the connection edge 11 and the trailing edge 14, are each extended by a vertical wall 15.

More particularly, from the connection edge 11 to the trailing edge 14, the face 10 is divided into a succession of four flat facets 16 to 19 conferring a substantially convex profile on the latter.

According to a preferred variant embodiment, the respective surface area of the facets 16 to 18 decreases from the connection edge 11 to the trailing edge 14, but the facet 19 nevertheless has a trailing surface area slightly greater than the surface area of the preceding facet 18 because of its importance in the diversion of the airstream.

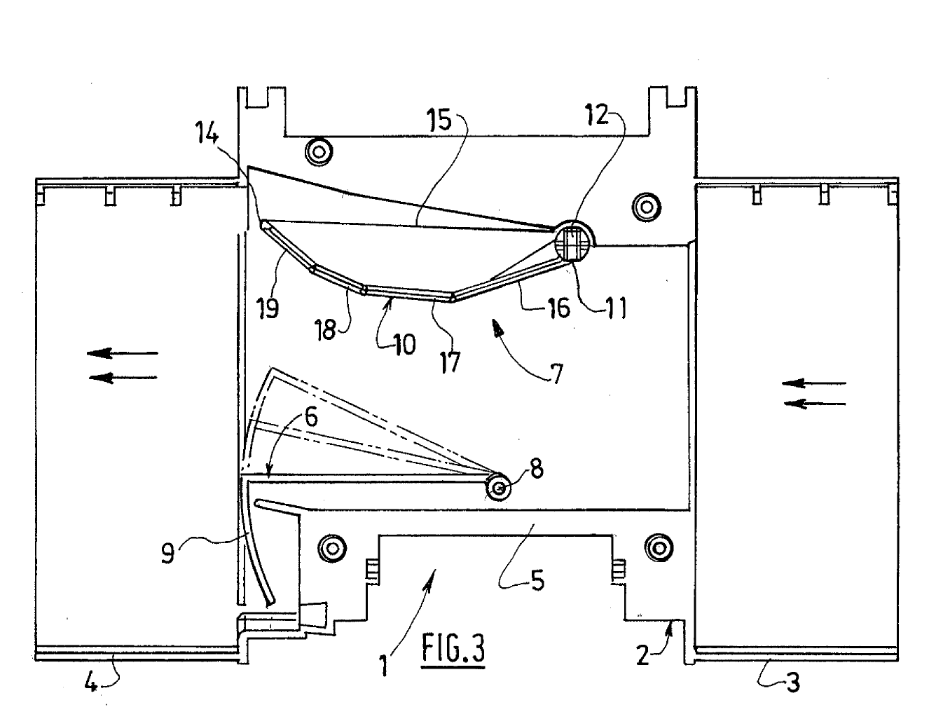

Specifically, it has been noted that it is advantageous to provide larger surface areas close to the connection edge 11 because, as shown in FIG. 3, when the delivered flow rate of air is at a maximum and when only the facets 16, 17 close to the connection edge 11 have an appropriate inclination with the regulation flap 6, the distance separating the setting flap 6 from the regulation flap 7 is also at a maximum.

On the other hand, because of the proximity of the regulation flap 6 in the case of a low-flow-rate regulation, as shown in FIG. 1, it has been noted that the effective interaction with the setting flap 7 does not make it necessary to confer as large a surface area on the facets 18, 19 that are placed in the vicinity of the trailing edge 14 and that alone have an appropriate inclination with the regulation flap 6.

Furthermore, it should be well understood that the ventilation outlet 1 incorporates manual and/or automatic control means (not shown) making it possible to change the position of the setting flap 7 about its shaft in order to modify the flow rate of air delivered by said ventilation outlet 1.

Although the invention has been described with reference to particular exemplary embodiments, it is quite evident that it is in no way limited thereto and that it includes all the technical equivalents of the means described and their combinations if the latter fall within the context of the invention.

1. A self-adjusting ventilation outlet with multiple flow rates having a passageway for the ventilation air and having a regulation flap, and comprising a setting flap, having a face designed to channel the incoming air and having, on the one hand, a connection edge fitted with attachment means allowing the setting flap to be attached about a shaft in a predetermined position, and, on the other hand, an opposite edge forming a trailing edge, characterized in that, from the connection edge to the trailing edge, the face of the setting flap is divided into a succession of flat facets conferring a substantially convex profile on the latter.

2. The ventilation outlet as claimed in claim 1, characterized in that the number of facets of the setting flap is between 2 and 10.

3. The ventilation outlet as claimed in claim 1, characterized in that the facet with the largest surface area of the setting flap is closest to the connection edge.

4. The ventilation outlet as claimed in claim 3, characterized in that the respective surface area of the facets of the setting flap decreases from the connection edge into the trailing edge.

5. The ventilation outlet as claimed in claim 3, characterized in that the surface area of the facet of the setting flap closest to the trailing edge is greater than the surface area of the facet preceding it.

6. The ventilation outlet as claimed in claim 1, characterized in that it comprises manual and/or automatic control means making it possible to change the position of the setting flap about its shaft.
